(19) United States
(12) Patent Application Publication
(10) Pub. No.: US 2012/0173350 A1
(43) Pub. Date: Jul. 5, 2012

(54) MOBILE APPLICATION FACILITATING RESTAURANT ACTIVITIES AND METHODS THEREOF

(76) Inventor: Doug Robson, Phoenix, AZ (US)

(21) Appl. No.: 13/339,652

(22) Filed: Dec. 29, 2011

Related U.S. Application Data
(60) Provisional application No. 61/429,541, filed on Jan. 4, 2011.

(51) Int. Cl. G06Q 30/00

(52) U.S. Cl. 705/16; 705/27.1

(57) ABSTRACT

The present disclosure relates to a client application and system for facilitating restaurant activities between a hostess, attendant and others involved in a restaurant. In one illustrative embodiment, an attendant for customers logs into the application. Through the application, the attendant can assign a table to the customers. Menu items can be displayed to the customers for order. The attendant in turn can take orders from the customers and provide them wirelessly to a point-of-sale. In the kitchen, the order can be received from the point-of-sale and processed. Thereafter, payment can be calculated for the orders. The calculated payment can be processed directly on the application or at the point-of-sale. When processed on the application, the payment is then displayed to the customer. The attendant can receive payment from the customers. The attendant can then close the session for the customers of the table.

### REFERENCE TO RELATED DISCLOSURES

This disclosure claims priority to U.S. Provisional Application Ser. No. 61/429,541 titled MOBILE APPLICATION FACILITATING RESTAURANT ACTIVITIES AND METHODS THEREOF to Doug Robson and Brian Pierce that was filed on Jan. 4, 2011 which is hereby incorporated by reference in its entirety.

### TECHNICAL FIELD

This disclosure generally relates to a wireless device, and more particularly, to an application operating on the wireless device for the ordering and payment of services provided by a restaurant.

### BACKGROUND

In a restaurant, customers are often greeted and asked to take a seat by a hostess. The hostess, in turn, provides a menu listing available items for order and their prices. The customer then places an order with an attendant. The attendant walks over to a point-of-sale system and records the order by the customers. The order is relayed to employees who fill the order. In a restaurant establishment, the order is sent to the grill area where kitchen employees cook and plate the food.

Restaurants have been using this process with little variation throughout the years. Disadvantages of this system include inaccuracies associated with filling orders. A main contributor to the problem of mistakes in orders is communication between the attendant and the customers. Furthermore, and adding to the complexity, attendants often take “mental notes” leading to botched orders.

After the food is served, payment also becomes an area where improvements can be made. Prior art systems have failed to recognize orders that are split between multiple parties at a single table. Typically, these systems allowed only one bill per table or at best, split between two parties. Coupons or other considerations were generally left out on the initial bill provided to the customers.

Accordingly, it can be seen that a need exists for a system which provides enhanced communication between customers, attendants and others within the restaurant. Furthermore, it would be advantageous to use current technology while not adding significant costs. These features as well as other related advantages will be described in the present disclosure.

### SUMMARY

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a mobile device having a display screen, a GUI provided for on the display screen, and an interactive menu displayed on the GUI is provided. The mobile device can include at least one processor and a memory operatively coupled to the processor, the memory storing program instructions that when executed by the processor, causes the processor to perform processes. The processes can include displaying the interactive menu through the GUI on the display screen and receiving at least one order entered through the interactive menu. In addition, the processes can include providing the at least one order to a point-of-sale whereat the at least one order is processed and receiving payment for the at least one order. The processes can also include providing the payment to the point-of-sale where the payment is processed.

In accordance with another aspect of the present disclosure, a system is provided. The system can include at least one wireless device in communication with a point-of-sale in a cloud-based network for a restaurant. The point-of-sale in the cloud-based network for the restaurant can receive orders from the at least one wireless device, forward the orders to locations within the restaurant for processing and calculate payments for the orders. The point-of-sale can return the calculated payment to the at least one wireless device.

In accordance with yet another aspect of the present disclosure, a computer implemented method is provided. The method can include opening a session for a table and displaying menu items for order. In addition, the method can include providing selected menu items from the menu items to a cloud-based interface and displaying a calculated payment for the selected menu items. The method can also include receiving payment from the table and closing the session for the table.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 provides an exemplary floor plan for a restaurant in accordance with one aspect of the present disclosure;

FIG. 2 depicts illustrative hardware and software components of a typical mobile device for the exemplary restaurant application in accordance with one aspect of the present disclosure;

FIG. 3 is a flow chart that shows features for the exemplary restaurant application in accordance with one aspect of the present disclosure;

FIG. 4 describes an illustrative screen for assigning tables in accordance with one aspect of the present disclosure;

FIG. 5 is an illustrative screen for adding customers as well as ordering items in accordance with one aspect of the present disclosure;

FIG. 6 provides an exemplary table for seating customers in accordance with one aspect of the present disclosure;

FIG. 7 depicts an illustrative screen for reviewing an order in accordance with one aspect of the present disclosure;

FIG. 8 is an illustrative screen for providing order alerts in accordance with one aspect of the present disclosure;

FIG. 9 provides an illustrative screen for splitting a bill in accordance with one aspect of the present disclosure;

FIG. 10 shows an illustrative screen for providing payment in accordance with one aspect of the present disclosure;

FIG. 11 shows an illustrative screen for administrating the exemplary restaurant application in accordance with one aspect of the present disclosure;

FIG. 12 is an illustrative screen for adding a restaurant in accordance with one aspect of the present disclosure;

FIG. 13 provides an illustrative screen for adding an employee in accordance with one aspect of the present disclosure;

FIG. 14 depicts an illustrative screen for providing restaurant information in accordance with one aspect of the present disclosure;

FIG. 15 is an illustrative screen for creating or updating a menu in accordance with one aspect of the present disclosure;

FIG. 16 shows an illustrative screen for creating or updating items in accordance with one aspect of the present disclosure;

FIG. 17 is an illustrative screen providing reports for the restaurant in accordance with one aspect of the present disclosure;

FIG. 18 provides a flow chart depicting illustrative processes for the system described herein in accordance with one aspect of the present disclosure; and

FIG. 19 shows illustrative processes for transferring data from the devices to a cloud server in accordance with one aspect of the present disclosure.

### DESCRIPTION OF THE DISCLOSURE

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

### System Overview

Generally described, the present disclosure relates to restaurants. More specifically, the present disclosure relates to a mobile application and system for facilitating restaurant activities between a hostess, attendant and others involved in a restaurant. In one illustrative embodiment, an attendant for customers logs into the application. Through the application, the attendant can assign a table to the customers. Menu items can be displayed to the customers for order. In turn, the attendant can take orders from the customers and provide them wirelessly to a point-of-sale. The point-of-sale can forward the orders to a proper location within the restaurant. Thereafter, payment can be calculated for the orders. The calculated payment can be processed directly on the application or at the point-of-sale. When processed on the application, the payment is then displayed to the customer. The attendant can receive payment from the customers. The attendant can then close the session for the customers of the table.

Numerous advantages can be provided through the client application and associated system. The client application can remove any inaccuracies related to orders as the attendant can confirm their order at the table. Furthermore, the associated system can provide desktop application printing functions that generate orders. In one embodiment, the client application and associated system can communicate through a cloud-based service known to those skilled in the relevant art. When multiple printers can be used, the orders can automatically be directed to the appropriate system. The client application and associated system can also be used within a WiFi® infrastructure.

While one embodiment was described above, other configurations will be described below and can be modified according to a restaurant's specific requirements. The present disclosure can be extended to other areas where orders are taken and relayed to another location, for example, in a drive-through. As will be shown below, the client application can be provided in a variety of forms and different interfaces. The application can be implemented as a standalone application on a smartphone or other wireless device. Many additional features and elements of the present disclosure will become apparent to those of ordinary skill in the art as provided for in the following description.

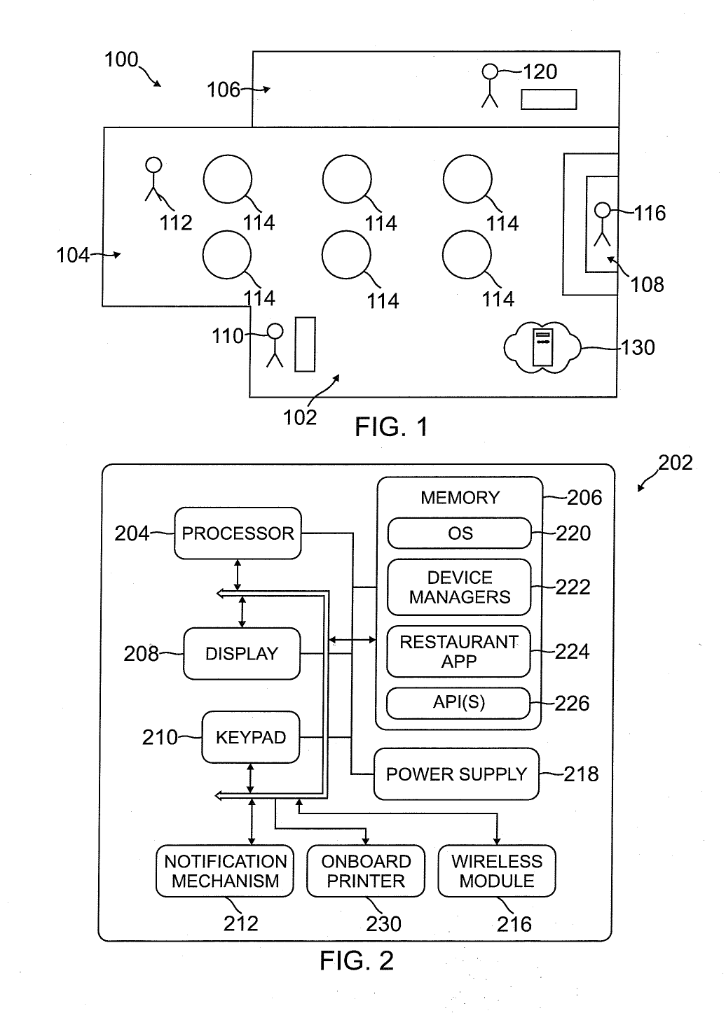

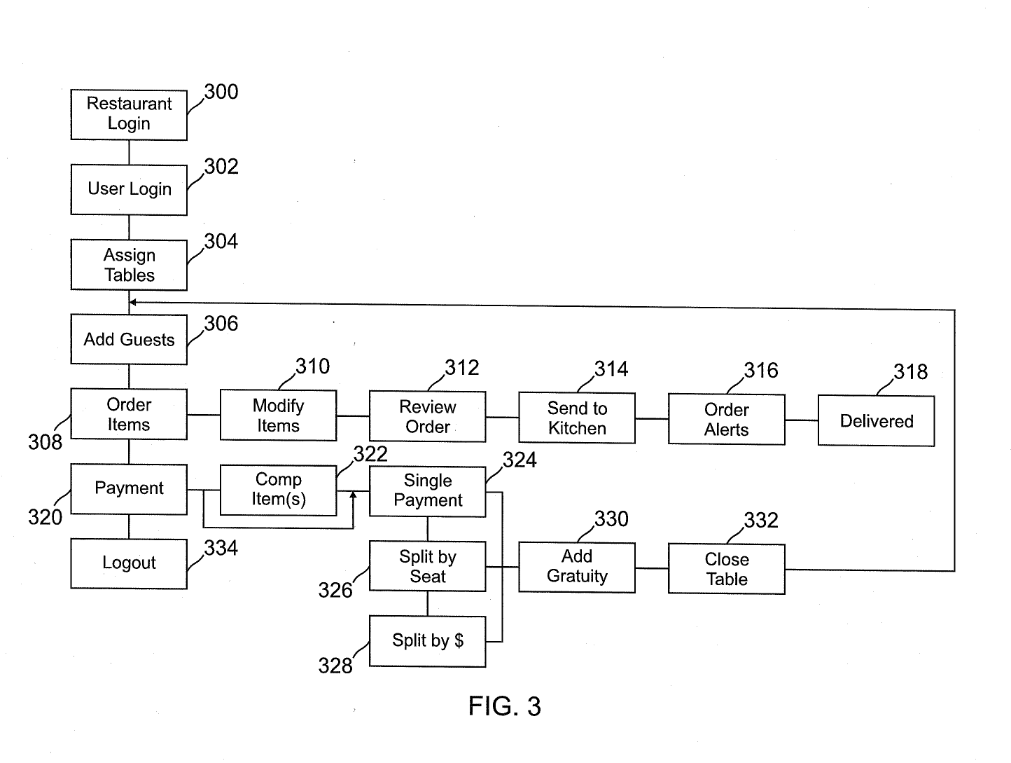

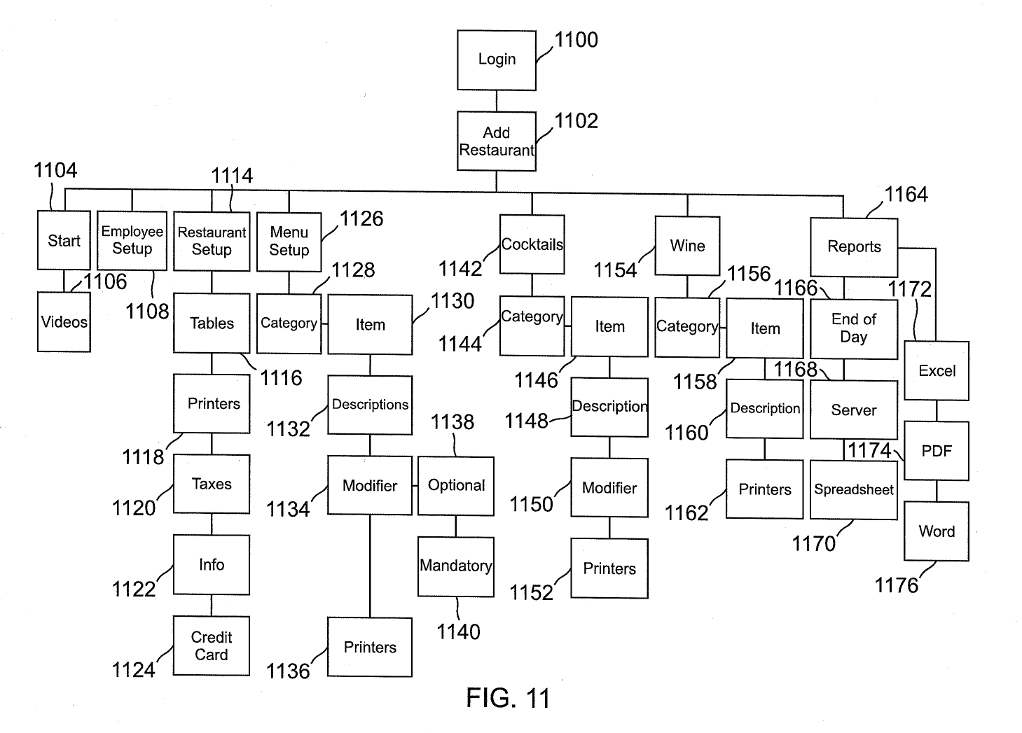

As will be shown below, FIG. 1 provides an illustrative environment for using the system and method. Exemplary hardware and software for a mobile device for use with the restaurant application will then be described in FIG. 2. FIGS. 3 through 10 will describe the mobile restaurant application followed by an administrative application shown in FIGS. 11 through 17.

### Mobile Device

Before describing specific operations of the mobile device, FIG. 1 provides an exemplary floor plan for a restaurant 100 in accordance with one aspect of the present disclosure. The restaurant 100 can include an entrance area 102 where customers are greeted by a hostess 110, a floor area 104 where orders are taken by an attendant 112 and a kitchen area 106 where chefs or cooks 120 prepare orders. Within the floor area 104 are a number of tables 114 for customers to be seated. Generally, the restaurant 100 can include a bar area 108 where drinks or other specialty items can be made by a bar tender 116.

While only six tables 114 are provided within the shown floor area 104, those skilled in the relevant art will appreciate that the restaurant 100 typically includes many more tables 114. Furthermore, multiple floor areas 104 for serving food and drinks can be provided. The attendant 112 also can have help from other persons within the restaurant 100, for example, busboys (not shown). In the present disclosure, a point-of-sale system 130 is provided in the restaurant 100 for working with mobile devices, which will be described below. The attendants 112 can each carry a mobile device for processing orders and payments for the tables 114.

The point-of-sale system 130 can be implemented in a cloud computing system whereby data is shared between a number of servers that provide resources, software and other data to each other. While the point-of-sale system 130 is illustrated as being one computer, those skilled in the relevant art will appreciate that one or many types of computing devices can be used to implemented the point-of-sale system 130. The point-of-sale system 130 can be Internet driven whereby web based tools can be used between the system 130 and mobile devices carried by the attendants 112. The mobile device can be programmed using typical web development techniques known to those skilled in the relevant art. Through the point-of-sale system 130, a restaurant 100 can provide data through a web access, set up an employee, menu items, time alerts and print out reports.

The point-of-sale system 130 can also facilitate the handling of orders made by the customers. For example, when a food order is taken by the attendant 112, it can be received by the point-of-sale system 130 and forwarded to the kitchen area 106. In the kitchen area 106, there can be a printer for printing out the orders. The printed orders can then be handled by the chefs 120 in the kitchen area 106. As will be shown below, the chef 114 can alert the point-of-sale system 130 that the order is completed. That information can then be sent to the attendant 112 or other party so that the food can be properly delivered to the table 114. Order alerts can also be sent.

In a similar way, when a drink order is made by a customer, the attendant 112 can provide that order to the point-of-sale system 130. The point-of-sale system 130 can determine that the order should be forwarded to the bar area 108. At the bar area 108, the bar tender 116 can prepare the drink. The bar area 108 can also include a printer. When finished, the bar tender 116 can alert the attendant 112 that the drink is finished through the point-of-sale system 130. Either the attendant 112 or busboy can then bring the drink to the table 114.

While the point-of-sale system 130 was used to forward either the drink or food order, those skilled in the relevant art will appreciate that the mobile device having the application thereon can be used as well to direct the order to the appropriate location. Furthermore, more than one attendant 112, hostess 110, chef 120 and bar tender 116 can be used within the restaurant 100.

The mobile device through the point-of-sale system 130 can connect with selected printers via WiFi, Ethernet or USB when orders are placed. The user can then select payment, apply payment, apply gratuity and close tables 114 as will be shown below. In one embodiment, the tables 114 can turn green indicating that an appropriate action has taken place. Alternatively, red can indicate that an inappropriate or no action has taken place. The system can activate a time alert in response.

FIG. 2 depicts illustrative hardware and software components of a typical mobile device 202 for the exemplary application in accordance with one aspect of the present disclosure. Those skilled in the relevant art will appreciate that other types of devices can be used for transferring order information and processing payments. Generally speaking, in typical embodiments, the mobile device 202 can have a processor 204 for implementing logic, a memory 206, a display 208 and a keypad 210. The display 208 of the mobile device 202 can be a liquid crystal display (LCD), or any other type of display commonly used in mobile devices 202. The display 208 can be touch-sensitive, and can act as an input device. The keypad 210 can be a push button numeric dialing pad (such as on a typical telephone), a multi-key keyboard (such as a conventional keyboard), or any other device for inputting textual data.

The memory 206 generally includes both volatile memory (e.g., RAM) and non-volatile memory (e.g., ROM, Flash Memory, or the like). The non-volatile portion of the memory 206 can be used to store persistent information which should not be lost when the mobile device 202 is powered down. The mobile device 202 can include an operating system (OS) 220, such as Windows® CE or Windows Mobile available from Microsoft Corporation, Redmond, Wash., or other OS. The OS can reside in the memory 206 and be executed on the processor 204.

The memory 206 can also include one or more device managers 222 for interacting with one or more I/O devices. The device managers 222 can be software installed on the mobile device 202. A device manager 222 can correspond to each I/O device. In addition to the device manager 222, one or more application programs can be loaded into memory 206 and run on or in association with the operating system 220.

Also within the memory 206, a restaurant application 224 can be run on the mobile device 202, which allows the attendant to take in orders as well a process payment for the orders. More details will be provided below. The restaurant application 224 can be installed on the mobile device 202 through a network connection or via a direct link. Alternatively, the client application 224 can be preinstalled and can be part of the operating system 220 described above.

The memory 206 can also include a collection of one or more APIs 226 for facilitating wireless communication between the mobile device 202 and one or more remote I/O devices. The APIs 226 can be invoked by the applications to recognize and control the one or more remote I/O devices. In this manner, the mobile device 202 is able to take advantage of services or functionalities of the one or more remote I/O devices.

The mobile device 202 can also include a power supply 218, which can be implemented as one or more batteries, fuel cells, or other sources of electrical power. The power supply 218 might further include an external power source, such as an AC adapter or a powered docking cradle that supplements or recharges the batteries.

The mobile device 202 can also include one or more audio, visual, and/or vibratory notification mechanisms 212. These notification mechanisms 212 can be directly coupled to the power supply 218 so that when activated, they remain on for a duration dictated by the notification mechanism 212 even though the processor 204 and other components might shut down to conserve energy. Examples of notification mechanisms 212 can include one or more LEDs, an audio interface, and a vibration generator. The one or more LEDs, when used, can be programmed to indicate the status of the orders or payment. The audio interface, when used, can provide audible signals to, and receive audible signals from, the user. For example, the audio interface can be coupled to a speaker for providing audible output and to a microphone for receiving audible input, such as to facilitate a telephone conversation. The vibration generator, when used, can be programmed to vibrate to indicate a status of the orders or payment

The mobile device 202 can also include a wireless module 216, such as a WiFi® module that facilitates wireless connectivity between the mobile device 202 and the point-of-sale system 130. Typically, the wireless module 216 connects with the cloud-based system 130 near or around the mobile device 202 for facilitating the orders and payment. In one embodiment, an onboard printer 230 can be placed on the mobile device 202. The onboard printer 230 can be used to print out receipts of payment, orders made, etc.

### Client Application

Referring now to FIG. 3, a general flow chart that shows features for the exemplary restaurant application 224 in accordance with one aspect of the present disclosure is provided. The restaurant application 224 can provide numerous menus, selections and interfaces for the user. The user can be an attendant, waiter, waitress, hostess or other party associated with the restaurant 100. The processes for the user can begin at block 300 where the user can be asked to login to the restaurant. In one embodiment, logging in can begin by entering the restaurant name through the display 208 of the mobile device 202. The restaurant can be associated with a password to prevent unauthorized personnel from performing malicious activities.

A list of employees can be maintained by the restaurant application 224. The list can be managed by who is working the current shift, upcoming shifts, etc., i.e., labor schedules. Tables 114 can be assigned by the application 224 as new patrons come in. Break times can also be kept tracked of. For example, the employee can clock out on their device 202. In one embodiment, a manager can keep track of an employee's whereabouts through a GPS system that can communicate with the wireless module 216 located on the device 202. Classifications for the employees can also be kept such as a bar tender 116.

At block 302, the user can log in through normal processes, for example, by entering in their name and password. A keypad for entering a specific employee identification can be provided on the mobile device 202. In one embodiment, employee identification is limited to numeric identifiers, for example, “1234”. Block 300 can be interchanged with block 302 such that the user is required to log in before they log in to the restaurant 100.

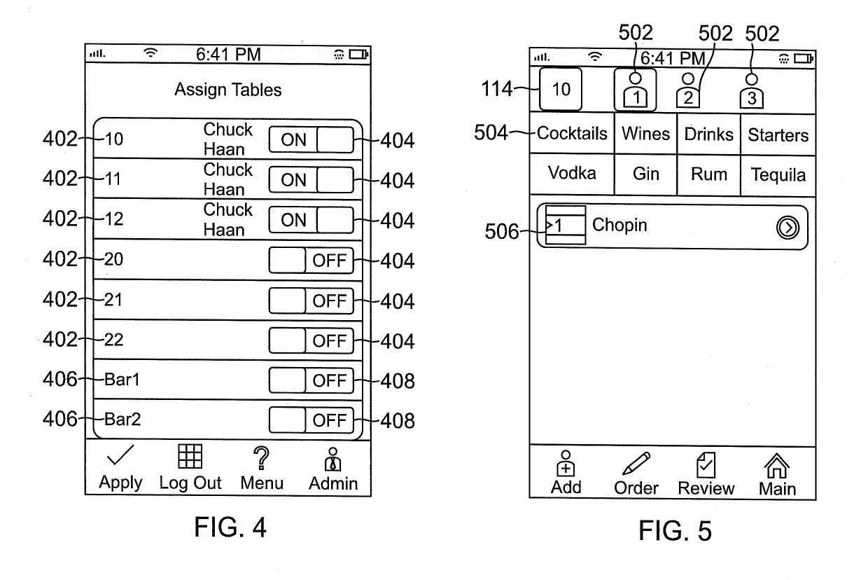

Tables 114 can be assigned at block 304. FIG. 4 describes an illustrative screen for assigning tables 114 in accordance with one aspect of the present disclosure. Each of the tables 114 in a restaurant 100 can be assigned a table number 402. A switch 404 on the restaurant application 224 can be turned “On” or “Off” indicating whether customers are sitting at a table 114. As further shown, the tables 114 can be assigned to a specific attendant 112. For purposes of illustration, tables 10, 11 and 12 have been assigned to “Chuck Haan”, while tables 20, 21 and 22 have not been assigned. In one embodiment, the hostess 110 of the restaurant 100 or maitre d′ can assign the tables 114.

The restaurant application 224 can show tables 114 within the restaurant 100 on a graphical user interface (GUI). Alternatively, the user can be familiar with table numbers in the restaurant 100. As further shown in FIG. 4, the bar area 108 can be assigned as well. Bar 1 and bar 2 406 can also incorporate a switch 404 for assigning a bar tender 116 to the bar area 108. Those skilled in the relevant art will also appreciate that the entrance area 102 can also be assigned to a hostess 110.

Continuing with FIG. 3, at block 306, customers can be added or removed from a table 114. The number of customers at a table 114 can vary as the size of a table 114 can vary as well. At block 308, items can be ordered by the customers and the user can input them into the application 224. FIG. 5 is an illustrative screen for adding customers 502 as well as ordering items in accordance with one aspect of the present disclosure.

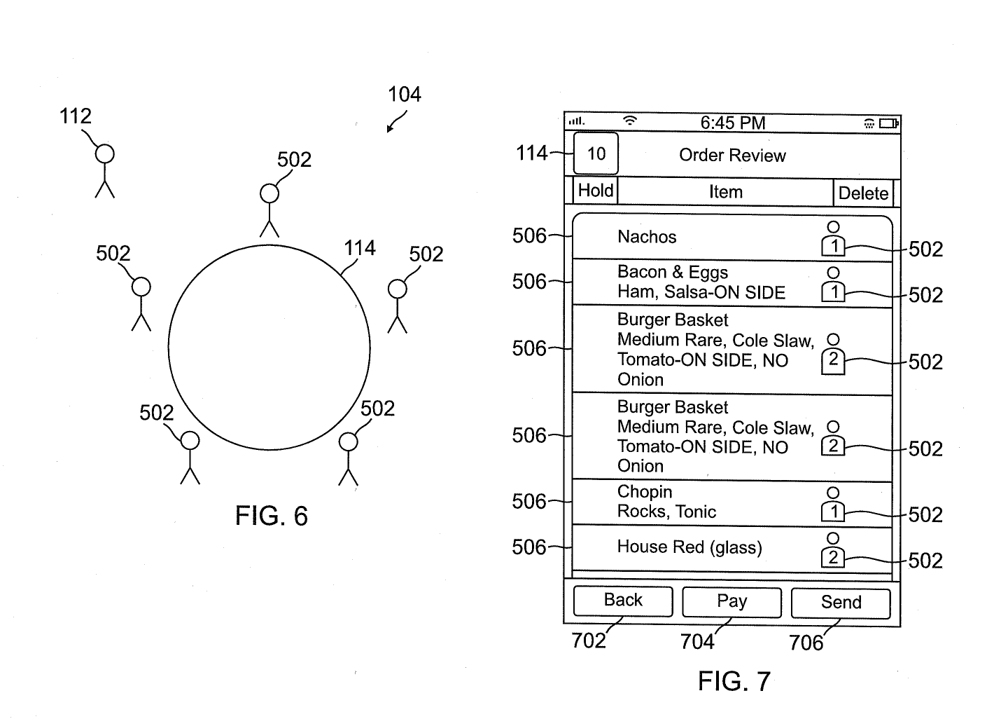

Customers can be added to a table 114 as shown in the top portion of the screen. For purposes of illustration, table 10 114 is shown. Customers 502 can be added or removed and displayed on the top portion. In this example, three customers 502 are shown. Known to those skilled in the relevant art, however, fewer or more customers 502 can be added or removed to the table 114. FIG. 6 provides an exemplary table plan for customers 502 in accordance with one aspect of the present disclosure. Each of the customers 502 can be assigned a seat number. Separate bills can be kept for each customer 502 according to their seat.

As further illustrated in FIG. 5, orders can be taken by the attendant 112 through the mobile device 202. A main menu can be provided that shows cocktails, wines, drinks and starters. Those skilled in the relevant art will appreciate that other categories of food or drinks can be displayed. The attendant 112 can scroll through menus 504 to display items associated with these categories. As shown, for example, the cocktails menu 504 can go into vodka, gin, rum and tequila submenus. A specific cocktail having vodka can be provided, for example, Chopin. Numerous other types of cocktails can be provided in the other submenus having gin, rum and tequila known to those skilled in the relevant art.

Generally, drink selections can be provided first, for example, cocktails, wines, soda, etc. Numerous options for the drinks can be displayed. A starter or appetizer screen can also be provided. Following, orders for main courses, desserts, etc. can be provided by the application 224. Returning to FIG. 3, at block 310, the items can be modified. These modifications can include special instructions, for example, beef can be cooked as rare, medium-rare, medium, etc.

The user can review the order with each customer at block 312. FIG. 7 depicts an illustrative screen for reviewing an order in accordance with one aspect of the present disclosure. In the upper left hand corner, the table 114 can be shown that the attendant 112 is servicing. The attendant 112 can change the table 114 simply by pressing on the tab. In the order review screen, items that have been ordered are shown in the left hand area 506. Any modifications are also shown, for example, “No Onion” or “On Side”. Drink orders are also provided to the customers 502. While drinks are shown separately from food orders from the specific customer 502, they can also be placed by each other according to that customer 502.

When there is something wrong with the order, the back button 702 can be pressed. At the pay button 704, the attendant 112 can provide the bill quickly even before the orders have been provided. Generally, however, this button 704 is pressed when the customers 502 are done. At block 314 of FIG. 3, the order can be sent to an associated system for processing. This can be done by pressing the send button 706 on the bottom portion of the screen.

While shown as one system 130 within FIG. 1, the system 130 can be distributed over multiple points over the restaurant 100. In one embodiment, the orders for the customers 502 can be sent to a cloud-based system after the send button 706 is pressed where it can be determined where to send the order. For example, the order for drinks can be sent to the bar tender 116 in the bar area 108 while the order for main dishes can be sent to the kitchen area 106 for prepping by the chefs 120. In one embodiment, starters or appetizers can be sent to a secondary area (not shown) within the kitchen area 106.

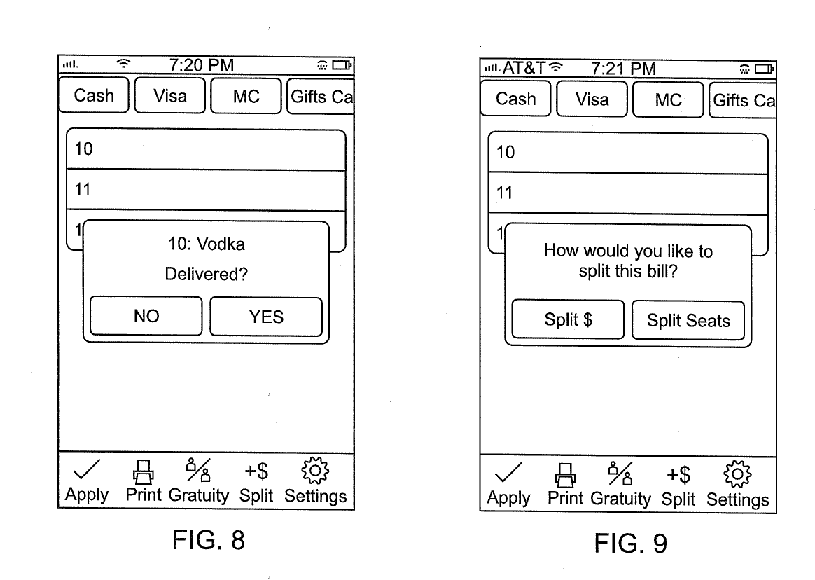

The restaurant application 224 can issue order alerts for the user to check the table 114 in certain situations at block 316. For example, the order can be completed and requires delivery to the table 114. Alternatively, the order has not been made and the attendant 114 or other party should check what the status of the order is. The notification mechanisms 212 on the mobile device 202 can be activated to vibrate, ring, light up, etc. In one embodiment, the tables 114 can turn red on a screen of the mobile device 202 to show that the drink or food needs to be delivered. On the screen, green can indicate that there is no further action required by the attendant 112 for that specific table 114. FIG. 8 is an illustrative screen for providing order alerts in accordance with one aspect of the present disclosure. For purposes of illustration, the screen provides a prompt on the mobile device 202 asking the attendant 112 whether the “Vodka” has been delivered. The restaurant application 224 can be programmed to define a time when the food should be done and sent to the table 114, which will be described in the administration section of the present disclosure.

Continuing with FIG. 3, at block 318, orders that have been delivered can be updated on the application 224. The alerts can be removed by the attendant 112 or other staff when the drink or food has been delivered. At block 320, the user can take in payment. In operation, many options can be provided by the restaurant application 224. Complementary orders can be received at block 322. The complementary orders can be provided as promotions to the restaurant 100. By offering payment services on the application 224, coupons or other discounts can be applied directly.

FIG. 9 provides an illustrative screen for splitting a bill in accordance with one aspect of the present disclosure. In one embodiment, the bill can be split by dollar amount or by seat amount. At block 324, the restaurant application 224 can be used to generate a single payment. At block 326, the billing can be split by seat or alternatively, the bill can be split by dollar amount at block 328. Those skilled in the relevant art will appreciate that there are numerous types of methods for retrieving payments from the customers. Gratuities can be added at block 330.

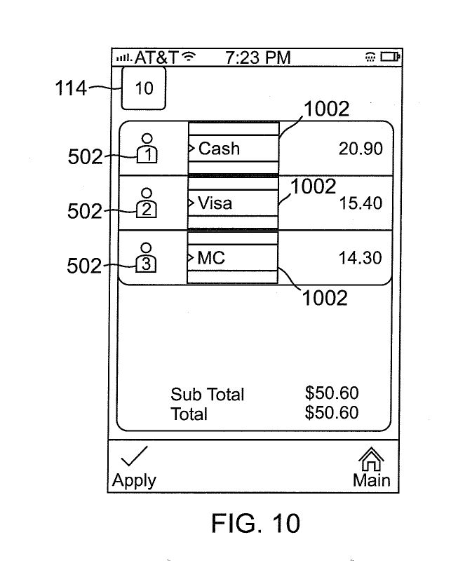

FIG. 10 shows an illustrative screen for providing payment in accordance with one aspect of the present disclosure. Each customer 502 can use a different form of payment. For example, customer 1 502 pays by cash 1002, customer 2 502 pays by credit card 1002 and customer 3 502 pays by credit card 1002. Other forms of payment 1002 can be used such as gift cards. The user, at block 332, can close out the table so that other customers can be served without closing out of the restaurant application 224. Alternatively, the processes can end at block 334 whereby the user can log out.

### Administrative Application

Referring now to FIG. 11, a general flow chart for administrating the exemplary restaurant application 224 in accordance with one aspect of the present disclosure is provided. The administrative application can be web based and operate on the point-of-sale system 130 in the cloud-based computing environment. The administrator can be provided with numerous menus, selections and interfaces through the application. An administrator can be a party who operates the restaurant 100 or the like. At block 1100, the processes can begin with the administrator logging in. The login screen generally asks the administrator to enter in a user name and password.

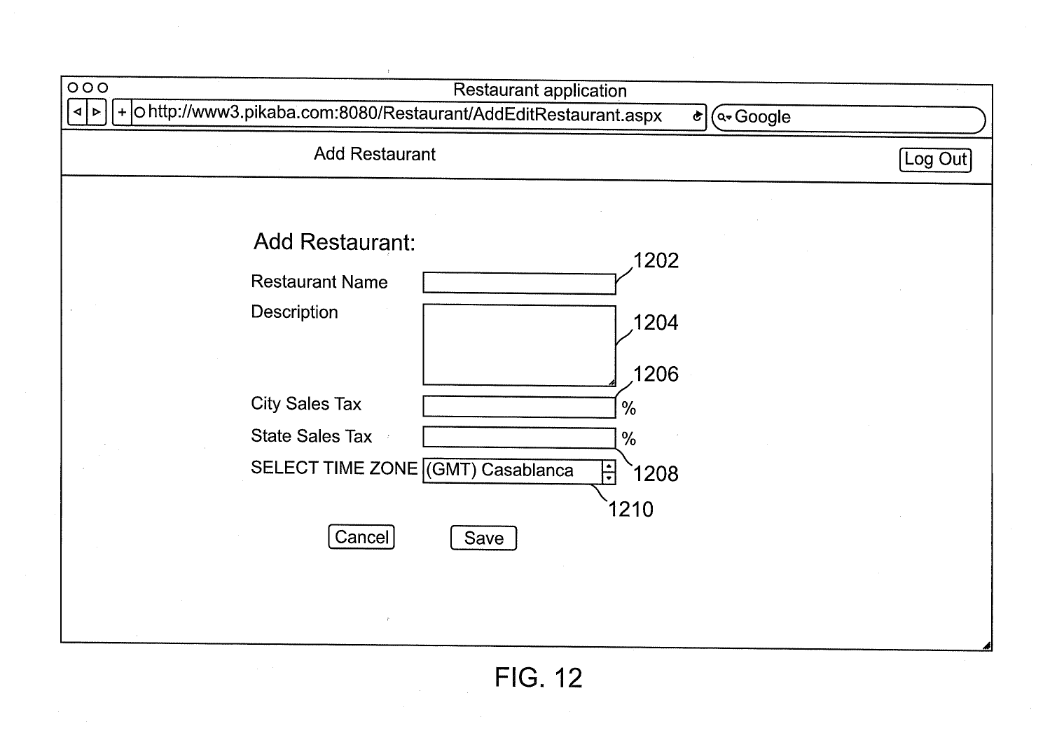

Initially and when generally no restaurants 100 have been established for the administrator, the system 130 requests that the administrator add in a restaurant at block 1102. FIG. 12 is an illustrative screen for adding a restaurant in accordance with one aspect of the present disclosure. Associated with each restaurant can be a name 1202, description 1204, city sales tax 1206, state sales tax 1208, etc. In addition, the administrator can select a time zone 1210 for the restaurant 100. Other information known to those skilled in the relevant art can also be used to establish the restaurant 100 within the point-of-sale system 130.

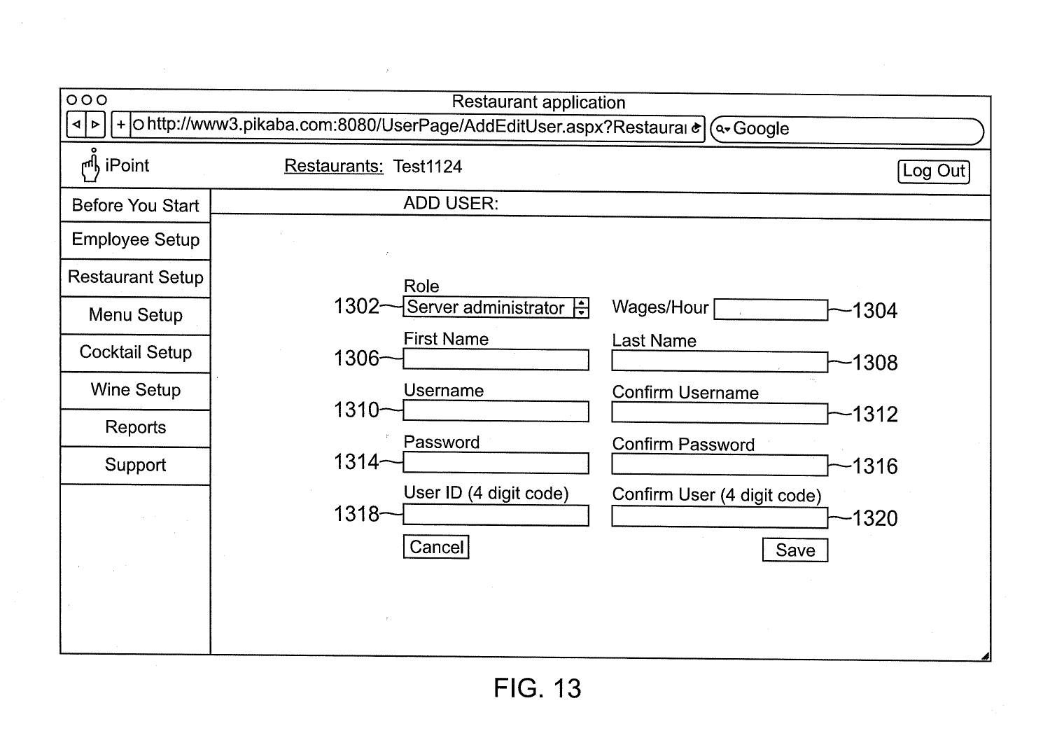

At block 1104, a start menu is provided. In one embodiment, the start menu provides a video tutorial for establishing the restaurant at block 1106. At block 1108, the administrator application can provide an employee setup menu. The employee information can be setup by the administrator so that the employees can use their mobile device 102 to provide orders and payment information. FIG. 13 provides an illustrative screen for adding an employee in accordance with one aspect of the present disclosure. Menus and submenus can be provided to facilitate employee setup. Slots for entering the first name 1306, last name 1308, username 1310, password 1314 and user id 1318 can be provided. Slots for confirming the username 1312, password 1316, and user id 1320 can also be provided. In one embodiment, the user id 1318 can be a four digit code. In one embodiment, previous paychecks and other related information to the employee can be kept in the same or separate menu. The information with the screen can be changed at any time.

Information about the restaurant can be setup at block 1114. At block 1116, tables 114 can be set up for the restaurant 100. Numbers can be assigned to tables 114 as well as the number of seats at each table 114. Printers can be established at block 1118. Printers can be provided at the entrance area 102, floor area 104, kitchen area 106 and bar area 108. In one embodiment, the printers can be used for order placements and delivery. The printers can work in combination with the point-of-sale system 130. The administrator, at block 1120, can setup a taxing structure for the restaurant 100.

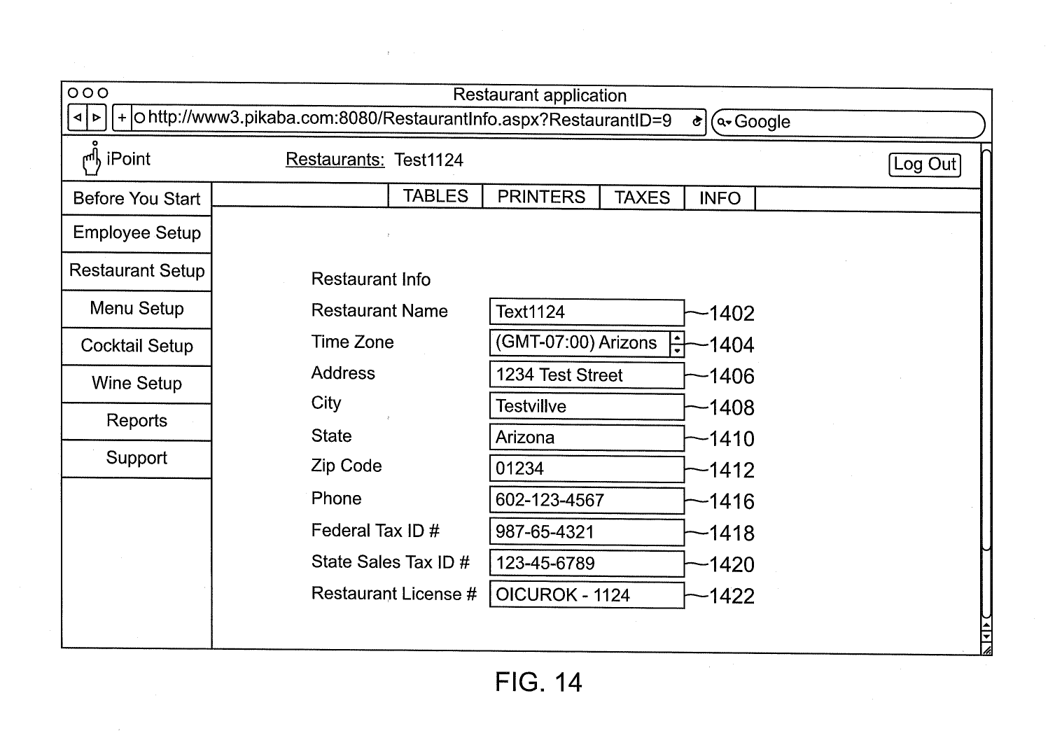

At block 1122, information can be setup for the restaurant 100. FIG. 14 depicts an illustrative screen for providing restaurant information in accordance with one aspect of the present disclosure. The restaurant name 1402, time zone 1404, address 1406, city 1408, state 1410, zip code 1412, phone 1416, federal tax identification number 1418, state sales tax identification number 1420 and restaurant license number 1422 can be filled in through the screen. Known to those skilled in the relevant art, other information can be provided. At block 1124, credit card usage information can be setup.

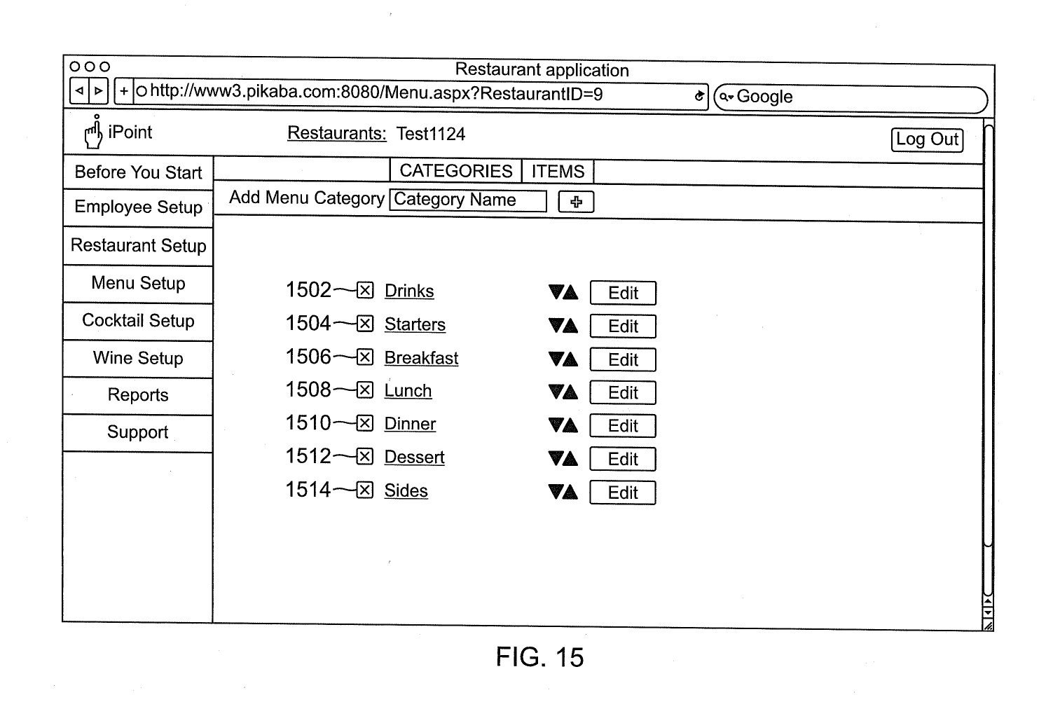

Continuing with FIG. 11, at block 1126, the administrator application can display a menu setup screen. At block 1128, the menu can be setup by categories. FIG. 15 is an illustrative screen for creating or updating a menu in accordance with one aspect of the present disclosure. The menu can provide a number of categories including drinks 1502, starters 1504, breakfast 1506, lunch 1508, dinner 1510, dessert 1512 and sides 1514. Each of these categories can be displayed through a number of menus and submenus. The information for the categories can be updated or edited through the screen.

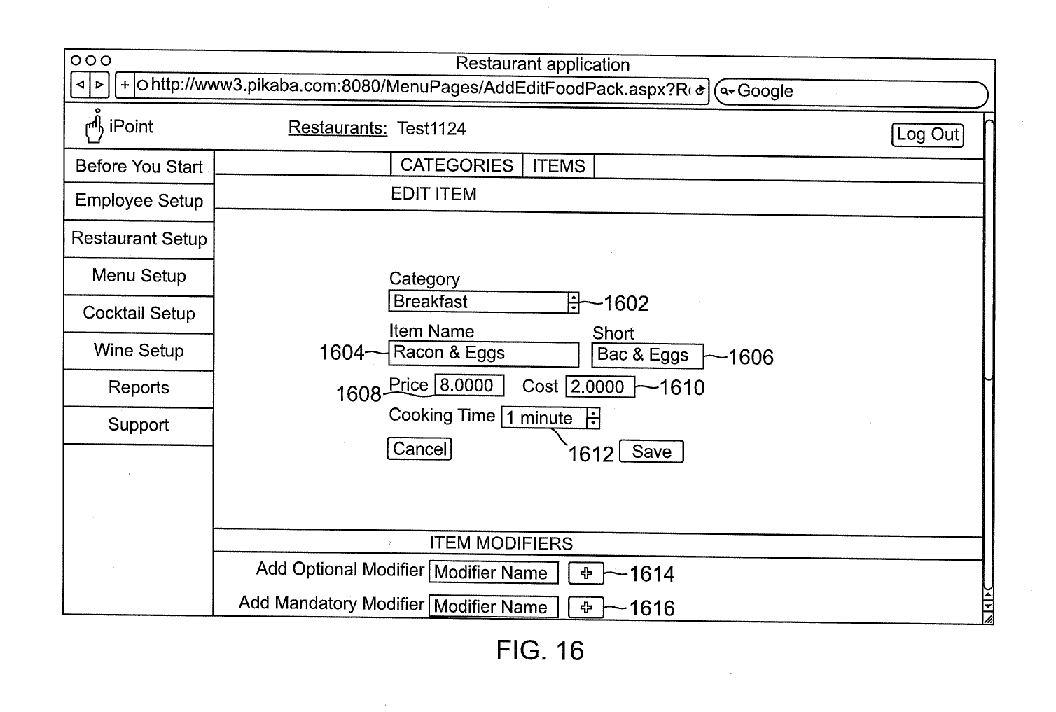

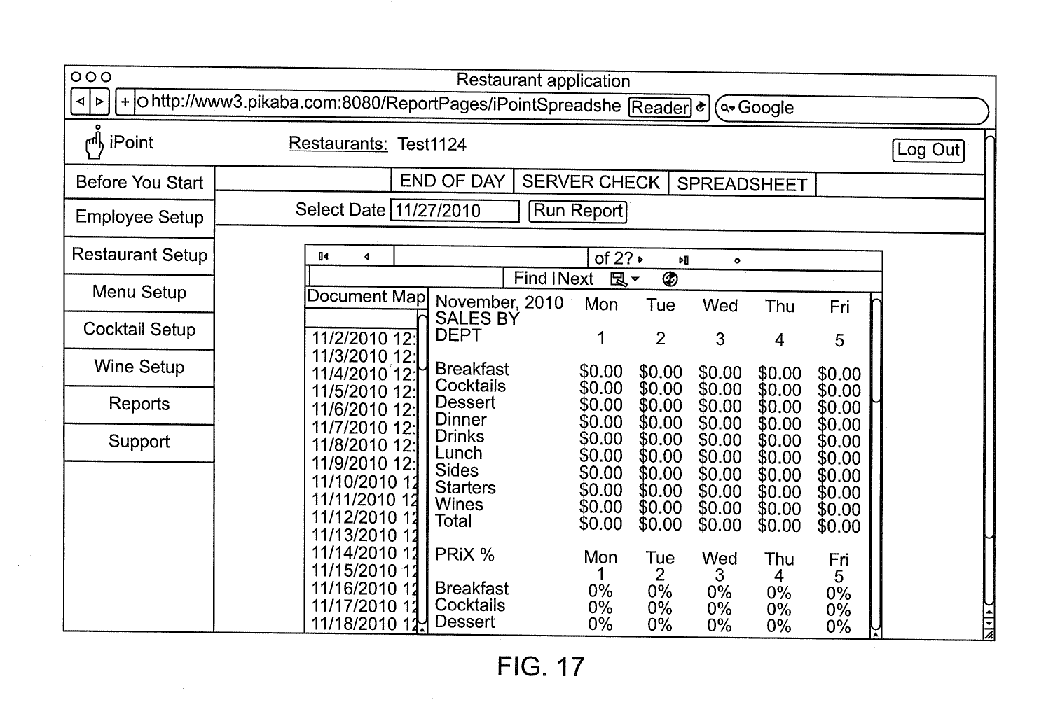

Items for order are also setup within the menus at block 1130. FIG. 16 shows an illustrative screen for creating or updating items in accordance with one aspect of the present disclosure. Editing items can be easily performed by category 1602, item name 1604, short name 1606, price 1608, restaurant cost 1610 and cooking time 1612. At block 1132, descriptions for each of the items can be provided.

Modifiers can be added in at block 1134. As shown in FIG. 16, optional modifiers 1614 at block 1138 and mandatory modifiers 1616 at block 1140 can be provided through the screen. Printers can be setup at block 1136 for the restaurant 100.

Continuing with FIG. 11, a cocktail menu can be provided at block 1142. At block 1144, different categories of cocktails can be listed within the menu. Categories can refer to the type of alcohol provided within the drink, for example, vodka, gin, rum and tequila. Within the categories, items are provided at block 1146. The items can refer to specific drinks having the category of alcohol in it. The cocktail menu can provide a description of the drinks at block 1148. At block 1150, modifiers can also be added to the item. Printers can be setup and associated with each of the items at block 1152. Priority levels can be set with each item.

Wine menus can be provided at block 1154. Generally, the wine can be categorized at block 1156. Specific items within each category can be provided at block 1158 along with a description at block 1160. Modifiers can also be added to the item. Printers can be setup and associated with each of the items at block 1162. Priority levels can be set with each item.

At block 1164, reports for the administrator can be provided. In one embodiment, an end of the day report can be generated and provided to the administrator at block 1166. Reports for individual servers can also be generated at block 1168. A spreadsheet can be provided at block 1170. The reports can be provided as excel documents at block 1172, PDFs at block 1174 and word documents at block 1176. FIG. 17 is an illustrative screen providing reports for the restaurant in accordance with one aspect of the present disclosure.

### Restaurant and Administrative Applications

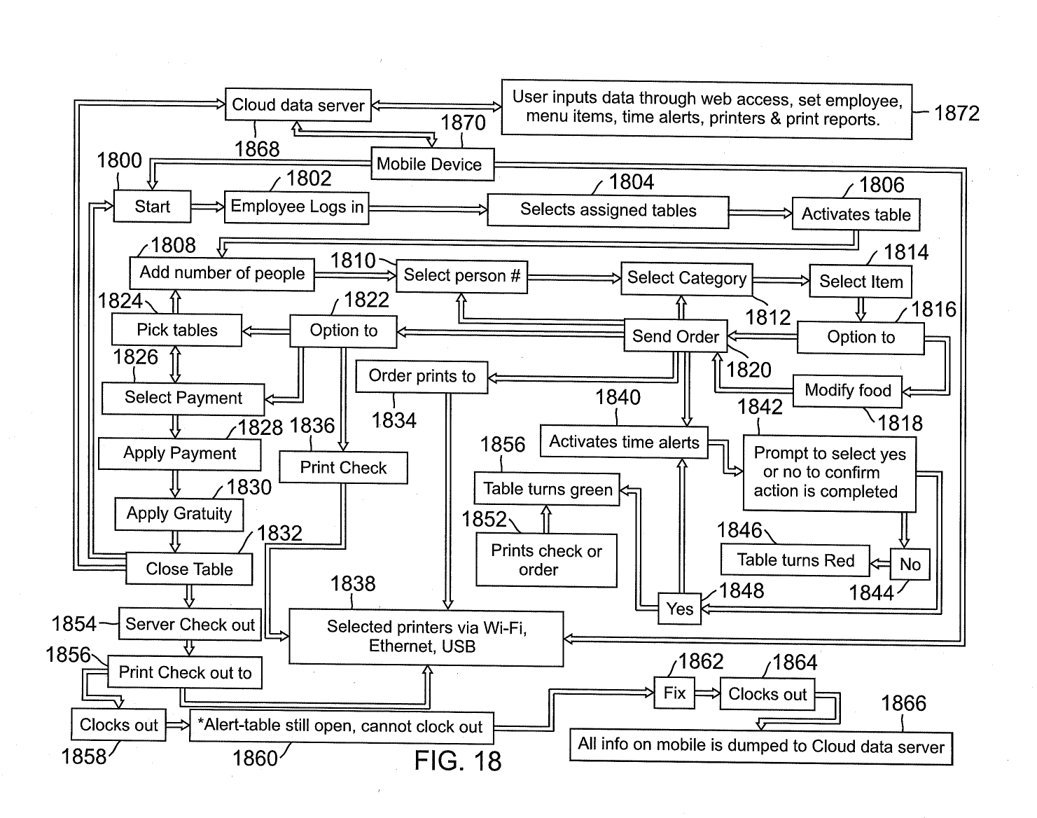

In combination, the restaurant application 224 and administrative applications, described above, can be used to create a system for facilitating restaurant activities between a hostess 110, attendant 112 and others involved in a restaurant 100. Turning now to FIG. 18, a flow chart depicting illustrative processes for the system described herein in accordance with one aspect of the present disclosure is provided. The processes can start at block 1800. The employee can log in at block 1802 through their assigned device 202. In one embodiment, the employee can log in through procedures known in the relevant art such as entering a username and password. This information can be set up by the administrator or the employee themselves. For purposes of illustration, the employee can be the attendant 112 described earlier.

At block 1804, the employee can assign tables 114 to customers 502 being seated by the hostess 110. Through the restaurant application 224, a graphical user interface can be provided that displays each of the tables 114 in the restaurant 100. At block 1806, the employee can activate the table 114 for the customers 502. The employee can add the number of people at block 1808.

Continuing with FIG. 18, the restaurant application 224 can allow for individual processing of orders. At block 1810, the employee can select a person number. At the table 114, in one embodiment, each of the customers 502 can be assigned a number so that the employee does not have to remember names. Similar methods have been used that are known to one skilled in the relevant art.

At block 1812, the employee can select a category. These categories can relate, but are not limited to, drinks, appetizers, main courses and desserts as described above. At block 1814, the employee can select an item within the categories. Numerous menus and submenus can be used to facilitate this process. The restaurant application 224, at block 1816, can provide an option to modify the item. When the customer 502 determines that they want to modify the item that is selected, the employee can do so at block 1818. At block 1820, the employee can send an order. The order can be sent each time an item is selected or after the entire table 114 has finished. If the customers 502 decide to add in other items, the employee can return to the categories at block 1812. When other customers 502 are at the table 114, the employee can select another person at block 1810.

At block 1822, the restaurant application 224 can provide an option to pick tables at block 1824 or select payment at block 1826. At block 1828, the payment can be applied after it is selected. At block 1830, gratuities can be applied. The table 114 can be closed at block 1832. These blocks can be traversed through using the restaurant application 224 as shown in FIG. 18.

When the table is closed, at block 1854, the server can check out. At block 1856, the system can print a check out to the customers 502. At block 1858, the system clocks out. The system can clock out the table 114 to show that it is available. An alert can be provided that the table 114 is still open and that it cannot clock out at block 1860. When there is an issue, it can be fixed at block 1862 so that it can clock out at block 1864. Thereafter, all the information on the mobile device 202 is dumped to a cloud data server 130 at block 1866.

Returning to block 1822, the employee can print a check at block 1836. The employee can select printers via WiFi, Ethernet, USB, etc. at block 1838. When the orders are sent at block 1820, the orders can also be printed at block 1834 and sent to block 1838. At block 1840, and when orders are sent, alerts can be activated that warn the employee about the status of the orders. While customers 502 are waiting for the food, the employee will be prompted to select “yes” or “no” on whether the action has been completed at block 1842. When the action has not been completed at block 1844, the table 114 turns red at block 1846 on the restaurant application 224. When the action is completed at block 1848, other alerts can be checked at block 1840. At block 1850, the table 114 can turn green when the order has been completed. Those skilled n the relevant art will appreciate that other colors, patterns, sounds, textures can be used to show alerts. At block 1852, the system can print checks or the order.

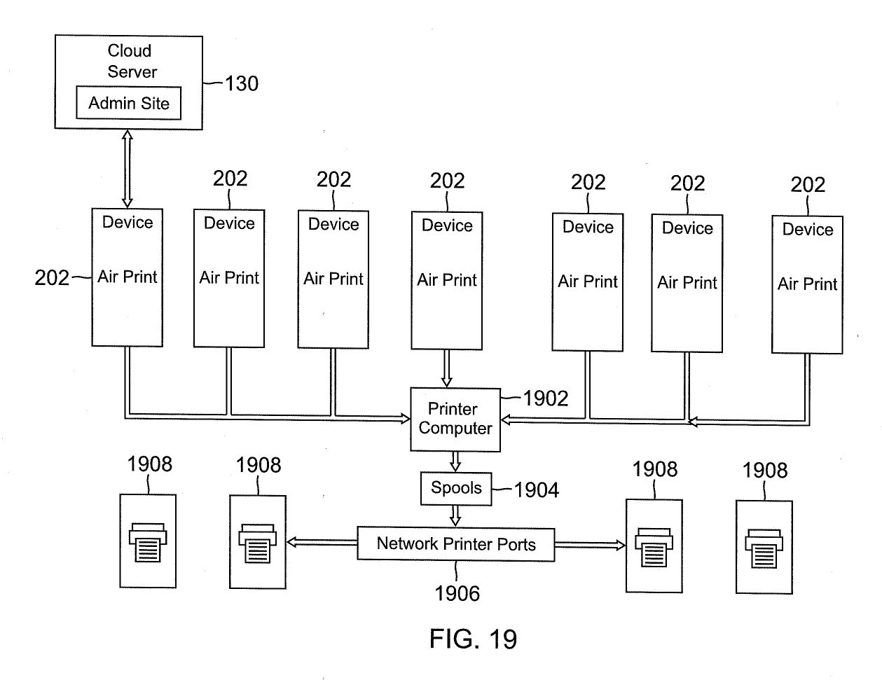

At the end of the processes, the data supplied to the devices 202 can be used to provide other info nation. FIG. 19 shows illustrative processes for transferring data from the devices 202 to a cloud server 130 in accordance with one aspect of the present disclosure. In one embodiment, the data is held on the devices 202 until the employee does their nightly checkout. Generally, when the device 202 is logged into the server 130, the server 130 cannot update its information until the end of the day or reset by the user. When the information is uploaded, the administrator can process it into reports and charts.

As shown in FIG. 19, each of the devices 202 can communicate with a printer computer 1902. The printer computer 1902 can determine the employee that is using the device 202. Spools 1904 can be used to process the orders. In one embodiment, the spools 1904 can process the orders using a queue structure. Alternatively, the spools 1904 can also use a prioritization system, known in the relevant art.

Network printer ports 1906 can be used to direct the orders to the right printer 1908. The printers 1908 can be placed throughout the restaurant 100 so that the order can be easily accessed. For example, a printer 1908 can be placed in the bar area 108 so that the bartender 116 can process drink orders.

### Variations

The system can manage inventory for a restaurant. For example, when a hamburger is ordered, the system can keep of buns, cheese and meat patties. The system can deduct those items required to make a hamburger from current inventory levels. Alcohol levels can also be accounted for to prevent unethical bar tending practices that can hinder the total profit from the drinks.

Additional variations to the current system can include one system handling multiple restaurants. The single system can, for example, handle a chain of restaurants. The system can manage inventory for those restaurants and direct delivery trucks to those stores requesting additional supplies. The inventory for a restaurant can be managed by Restaurant ID, Description, Inventory Date, Inventory Status, Create Date, Update Date and Item Quantity. Furthermore, the system can be networked over many areas. Vendor lists for the inventory can be directly contacted through the system providing a seamless integration of the systems. The number of condiments, silverware, plates, bowls, etc. can also be monitored by the system.

As discussed earlier, payment systems can be kept track of. Weekly salary costs can be maintained as well as profit margins. In one embodiment, project sales can be determined. The projected sales can account for weekends and weekdays, i.e., the restaurant is likely to take in more money during the weekend than the weekday, but yet still have additional costs due to labor and the scheduling of more employees. The system can also make projections for employee utilization. For example, the system can account for a holiday weekend requiring more employees.

### Systems, Methods and Operations

In accordance with one aspect of the present disclosure, a mobile device having a display screen, a GUI provided for on the display screen, and an interactive menu displayed on the GUI is provided. The mobile device can include at least one processor and a memory operatively coupled to the processor, the memory storing program instructions that when executed by the processor, causes the processor to perform processes. The processes can include displaying the interactive menu through the GUI on the display screen and receiving at least one order entered through the interactive menu. In addition, the processes can include providing the at least one order to a point-of-sale whereat the at least one order is processed and receiving payment for the at least one order. The processes can also include providing the payment to the point-of-sale where the payment is processed.

In one embodiment, displaying the interactive menu can include providing at least one category, at least one item associated with the at least one category and a description for the at least one item on the GUI. In one embodiment, the memory storing program instructions when executed by the processor can cause the processor to display a table setup. In one embodiment, the memory storing program instructions when executed by the processor can cause the processor to receive a seating arrangement according to the table setup.

In one embodiment, the memory storing program instructions when executed by the processor can cause the processor to provide a review order screen. In one embodiment, the at least one order can be at least one of a drink, cocktail, appetizer, main course and dessert. In one embodiment, receiving the at least one order entered through the interactive menu can include adding at least one of an optional modifier and mandatory modifier.

In one embodiment, the point-of-sale can be provided in a cloud-based network. In one embodiment, the memory storing program instructions when executed by the processor can cause the processor to provide an alert screen for indicating that the at least one order needs to be delivered. In one embodiment, receiving the payment for the at least one order and providing the payment to the point-of-sale can include splitting the payment between customers. In one embodiment, splitting the payment between customers can include splitting the payment by seat. In one embodiment, splitting the payment between customers can include splitting the payment by dollar amount.

In accordance with another aspect of the present disclosure, a system is provided. The system can include at least one wireless device in communication with a point-of-sale in a cloud-based network for a restaurant. The point-of-sale in the cloud-based network for the restaurant can receive orders from the at least one wireless device, forward the orders to locations within the restaurant for processing and calculate payments for the orders. The point-of-sale can return the calculated payment to the at least one wireless device.

In one embodiment, the system can include a printer for printing the orders at each of the locations within the restaurant. In one embodiment, the locations can include at least one of a kitchen area, bar area and floor area of the restaurant. In one embodiment, the point-of-sale can be programmed through an administrator through a web-based interface with the cloud-based network.

In accordance with yet another aspect of the present disclosure, a computer implemented method is provided. The method can include opening a session for a table and displaying menu items for order. In addition, the method can include providing selected menu items from the menu items to a cloud-based interface and displaying a calculated payment for the selected menu items. The method can also include receiving payment from the table and closing the session for the table.

In one embodiment, the menu items can be programmed by an administrator. In one embodiment, receiving the payment from the table can include splitting the payment between customers at the table by seat. In one embodiment, the cloud-based interface can process the selected menu items and forward them to an area for processing.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The technology described herein can be implemented as logical operations and/or modules. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying environment in which the described disclosure is implemented. The logical operations making up the embodiment of the disclosure described herein are referred to variously as operations, steps, objects, or modules. It should be understood that logical operations can be performed in any order, unless explicitly claimed otherwise or a specific order is inherently necessitated by the claim language.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

In software implementations, computer software and/or data is stored on a machine readable medium as part of a computer program product, and is loaded into a computer system or other device or machine via a removable storage drive, hard drive, or communications interface. Computer programs, also called computer control logic or computer readable program code, are stored in a main and/or secondary memory, and executed by one or more processors, controllers, or the like to cause the one or more processors to perform the functions of the disclosure as described herein.

The figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present disclosure, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A mobile device having a display screen, a graphical user interface (GUI) provided on said display screen and an interactive menu displayed on said GUI, said device comprising:
at least one processor; and
a memory operatively coupled to said processor, said memory storing program instructions that when executed by said processor, causes said processor to:
display said interactive menu through said GUI on said display screen;
receive at least one order entered through said interactive menu;
provide said at least one order to a point-of-sale whereat said at least one order is processed;
receive payment for said at least one order;
provide said payment to said point-of-sale where said payment is processed.

2. The mobile device of claim 1, wherein displaying said interactive menu comprises providing at least one category, at least one item associated with said at least one category and a description for said at least one item on said GUI.

3. The mobile device of claim 1, wherein said memory storing program instructions when executed by said processor causes said processor to display a table setup.

4. The mobile device of claim 3, wherein said memory storing program instructions when executed by said processor causes said processor to receive a seating arrangement according to said table setup.

5. The mobile device of claim 1, wherein said memory storing program instructions when executed by said processor causes said processor to provide a review order screen.

6. The mobile device of claim 1, wherein said at least one order is at least one of a drink, cocktail, appetizer, main course and dessert.

7. The mobile device of claim 1, wherein receiving said at least one order entered through said interactive menu comprises adding at least one of an optional modifier and mandatory modifier.

8. The mobile device of claim 1, wherein said point-of-sale is provided in a cloud-based network.

9. The mobile device of claim 1, wherein said memory storing program instructions when executed by said processor causes said processor to provide an alert screen for indicating that said at least one order needs to be delivered or is late.

10. The mobile device of claim 1, wherein receiving said payment for said at least one order and providing said payment to said point-of-sale comprises splitting said payment between customers.

11. The mobile device of claim 10, wherein splitting said payment between customers comprises splitting said payment by seat.

12. The mobile device of claim 10, wherein splitting said payment between customers comprises splitting said payment by dollar amount.

13. A system comprising:
at least one wireless device in communication with a point-of-sale in a cloud-based network for a restaurant;
wherein said point-of-sale in said cloud-based network for said restaurant receives orders from said at least one wireless device, forwards said orders to locations within said restaurant for processing and calculates payments for said orders, said point-of-sale returning said calculated payment to said at least one wireless device.

14. The system of claim 13, comprising a printer for printing said orders at each of said locations within said restaurant.

15. The system of claim 13, wherein said locations comprise at least one of a kitchen area, bar area and floor area of said restaurant.

16. The system of claim 13, wherein said point-of-sale is programmed through an administrator through a web-based interface with said cloud-based network.

17. A computer implemented method comprising:
opening a session for a table;
displaying menu items for order;
providing selected menu items from said menu items to a cloud-based interface;
displaying a calculated payment for said selected menu items;
receiving payment from said table; and
closing said session for said table.

18. The computer implemented method of claim 17, wherein said menu items are programmed by an administrator.

19. The computer implemented method of claim 17, wherein receiving said payment from said table comprises splitting said payment between customers at said table by seat.

20. The computer implemented method of claim 17, wherein said cloud-based interface processes said selected menu items and forwards them to an area for processing.
